(19) United States
(12) Patent Application Publication
(10) Pub. No.: US 2021/0174268 A1
(43) Pub. Date: Jun. 10, 2021

(54) SYSTEM FOR MANAGING THE USE OF EXERCISE EQUIPMENT AND FACILITIES

(71) Applicant: Campus Fitness Solutions LLC, Short Hills, NJ (US)

(72) Inventors: David Marc Levinson, Short Hills, NJ (US); Michael Jesse Levinson, Short Hills, NJ (US); Gregory Armand Jandoli, Sparta, NJ (US); Gregory Jandoli, Sparta, NJ (US)

(21) Appl. No.: 17/102,231

(22) Filed: Nov. 23, 2020

Related U.S. Application Data
(60) Provisional application No. 62/939,098, filed on Nov. 22, 2019.

(51) Int. Cl. G06Q 10/02; G06Q 10/10; G06Q 50/10; A63B 24/00

(52) U.S. Cl. CPC G06Q 10/02; A63B 24/0062; G06Q 50/10; G06Q 10/10

(57) ABSTRACT

A system for effectively and efficiently managing the use of exercise facilities, activities, and equipment. The system includes one or more exercise apparatuses forming a network. A mobile unit is electronically coupled to the one or more exercise apparatuses. The mobile unit includes a user control interface and a processor for executing a mobile application that activates content displayed on the user control interface. The content displayed on the user control interface may be engaged by the user to generate signals transmitted from the mobile unit to the one or more exercise apparatuses via near-field communication. A booking server in electronic communication with the mobile unit stores and transmits data to the mobile unit concerning the status of the one or more exercise apparatuses.

### CROSS REFERENCE TO RELATED APPLICATION

The present application claims priority under 35 USC § 119(e) to U.S. Provisional Patent Application No. 62/939,098, filed Nov. 22, 2019, the disclosure of which is hereby incorporated by reference in its entirety for all purposes.

### TECHNICAL FIELD

The present disclosure generally relates to health and fitness, and more specifically, to systems and methods for managing the use of exercise equipment, fitness studios, and recreation rooms.

### BACKGROUND

Balancing the life of a busy professional or a college student can be very challenging. For example, for a college student, between class lectures, homework, labs, studying for tests, socializing and participating in extracurricular activities, fraternities/sororities, and clubs, little time is left for physical fitness. A professional also has little time left for physical fitness when he or she has to juggle work and family duties. So when the professional or the student desires to go to the gym, often times the gym is overcrowded so they will waste time by going to the gym and having to wait until equipment is available for use, time that could otherwise be used to do other work, to study for classes or complete homework. Presently, there is not an easy way to know what is happening at the gym (events, workout classes, etc.), so a user cannot readily ascertain whether the gym is crowded or not, or whether certain exercise equipment is available for use.

The results of proper and consistent exercise manifest better sleep habits, stress relief, long/short term improvement in mood, and increased mental alertness. Aerobic exercise can be fundamental in preventing and treating panic attacks as well as aiding people at risk of developing anxiety disorders. People often report higher levels of confidence, newfound abilities for coping with stress, and greater independence in their daily activities when they are involved in regular fitness. The positive development in mood is due to an exercise-induced increase in blood circulation to the brain, influencing physiologic reactivity to stress. Some studies demonstrate increased success of those who regularly engage in fitness training, including, for example, higher GPA's and graduation rates for students.

In addition, connecting users with similar hobbies and interests can be difficult. It is also difficult to monitor workouts and fitness progress and users can be intimidated by gym machines and equipment when they do not know how to properly use them.

Further, facility managers and health and wellness departments or programs presently do not have the ability to monitor the use of fitness equipment in real-time and to communicate services and opportunities that drive certain fitness behavior.

A need, therefore, exists for an equipment management system that addresses the aforementioned problems. With the use of the present disclosure, users will be encouraged and find it easier and more convenient to engage in physical fitness.

### SUMMARY

Disclosed here, therefore, are downloadable software application and computer-implemented techniques and systems for managing the use of exercise equipment. In some embodiments, a system of the present disclosure may include one or more exercise apparatuses and one or more stations forming an exercise activity network. The system may also include a mobile unit for communicating with the one or more exercise apparatuses. The mobile unit may include at least one processor, a non-transitory computer-readable medium including computer-executable program instructions executable by the processor, a network interface, a user control interface, and data storage for storing at least a mobile application that, when executed, may activate content displayed on the user control interface. The mobile unit communicates with an electronic circuit coupled to the one or more exercise apparatuses when the mobile unit is placed in proximity to the electronic circuit. The mobile unit communicates with the electronic circuit via near-field communications.

The system may also include a booking server. The booking server may include at least one processor, a non-transitory computer-readable medium including computer-executable program instructions executable by the processor, and a network interface configured to operatively connect the server in electronic communication with the mobile unit and the apparatuses. The booking server may receive information data concerning the status of the one or more apparatuses, store and transmit to the mobile unit information data concerning the status of the one or more exercise apparatuses.

In some implementations, the mobile unit may continuously broadcast a location identifier to the booking server. The location identifier may be unique to the mobile device and may include or represent location information of the mobile device relative to a certain object (e.g., equipment) receiving the location identifier. The location of the equipment may also be mapped in the system. Once a user is active on that equipment, the user's location may be shared via the network. If the equipment is moved or relocated, the location for the equipment may be re-mapped.

A method of managing the use of an exercise activity is also disclosed. The method includes populating a database stored on a computing device with information concerning one or more exercise activities. The information concerning one or more exercise activities include a unique serial number assigned to each exercise activity.

The method also includes launching a mobile application executed by a mobile unit. The mobile unit is in electronic communication with the database via a wireless connection for receiving and transmitting information about the status of the one or more exercise activities.

The method further includes energizing an electric circuit coupled to one or more exercise activities by placing the mobile unit in close proximity to the electric circuit. The electric circuit transmits data comprising an alphanumeric identifier to the mobile unit. The data is processed by the mobile application to generate a status signal comprising the alphanumeric identifier.

The method further includes transmitting the status signal from the mobile unit to the computing device where the database is searched to match the alphanumeric identifier with information concerning an exercise activity associated with a serial number having the name alphanumeric characters. The computing device delineates the exercise activity associated with a serial number having the same alphanumeric characters as the alphanumeric identifier.

The method moreover includes updating the status of the delineated exercise activity in the database from “available” to “in use.”

In some implementations, the method may further include energizing the electric circuit a second time by placing the mobile unit in close proximity to the electric circuit. The electric circuit transmits data comprising the alphanumeric identifier to the mobile unit. The data is processed by the mobile application to generate a second status signal comprising the alphanumeric identifier

In some implementations, the method may further include transmitting the status signal from the mobile unit to the computing device where the database is searched to match the alphanumeric identifier with information concerning an exercise activity associated with a serial number having the name alphanumeric characters. The computing device delineates the exercise activity associated with a serial number having the same alphanumeric characters as the alphanumeric identifier and updates the status of the delineated exercise activity in the database from “in use” to “available.”

The disclosure of the invention in this summary is not an extensive overview of all contemplated embodiments, it should be appreciated that many other features, applications, embodiments, and/or variations of the disclosed technology will be apparent from the accompanying drawings and the following detailed description, while multiple embodiments are disclosed, however, the drawings and detailed description are to be regarded as illustrative in nature and not restrictive.

### BRIEF DESCRIPTION OF THE DRAWINGS

This disclosure may be better understood by referring to the following figures. The components in the figures are not necessarily to scale, emphasis instead being placed upon illustrating the principles of the disclosure. In the figures, like reference numerals designate corresponding parts throughout the different views.

FIG. 1 illustrates an example of a system for identifying persons who have been in contact with a person infected with an infectious disease, according to the teachings of the present disclosure.

FIG. 2A illustrates a detailed schematic diagram of the functions and features of a mobile application installed on a mobile unit, according to the teachings of the present disclosure.

FIG. 2B illustrates an example of a homepage of the mobile application of FIG. 2A.

FIG. 3 illustrates an example of a user control interface displaying a “Home” page, “Check-In” page, “Select Friends” page, and “Alert Message” page of the mobile application of FIG. 2A.

FIG. 4 illustrates an example of a user control interface displaying the Selectorized Equipment sub-feature of the Workouts feature of the mobile application of FIG. 2A.

FIG. 5 illustrates an example of a user control interface displaying the Cardio Equipment sub-feature of the Workouts feature of the mobile application of FIG. 2A.

FIG. 6 illustrates an example of a user control interface displaying the Group Fitness feature of the mobile application of FIG. 2A.

FIG. 7 illustrates an example of a user control interface displaying various functions of the Workouts History feature of the mobile application of FIG. 2A.

FIG. 8 illustrates an example of a user control interface displaying the Facilities feature of the mobile application of FIG. 2A.

FIG. 9 illustrates an example of a user control interface displaying various functions of the Social feature of the mobile application of FIG. 2A.

FIG. 10 illustrates an example of a user control interface displaying various functions of the My Profile feature of the mobile application of FIG. 2A.

FIG. 11 illustrates an example logic chart of the Workout feature of the mobile application of FIG. 2A.

FIG. 12 illustrates an example logic chart of the User Profile feature of the mobile application of FIG. 2A.

FIG. 13 illustrates an example logic chart of Settings feature of the mobile application of FIG. 2A.

FIG. 14 illustrates an example logic chart of the Group Fitness feature of the mobile application of FIG. 2A.

FIG. 15 illustrates an example logic chart of the Facilities feature of the mobile application of FIG. 2A.

FIG. 16 illustrates an example logic chart of the Social feature of the mobile application of FIG. 2A.

FIG. 17 illustrates an example logic chart of the What's Happening feature Social feature of the mobile application of FIG. 2A.

FIG. 18 is a flow chart of a method of managing the use of exercise equipment, according to the teachings of the present disclosure.

FIG. 19 illustrates an exemplary overall platform in which various embodiments, implementations and process steps disclosed herein can be implemented.

### DETAILED DESCRIPTION

Provided herein are example embodiments of systems and methods for effectively and efficiently managing exercise apparatuses. In some embodiments, the apparatuses may be located in a gym, in-dorm recreation, fitness room, recreation center, or other recreational and fitness facilities. The apparatuses may communicate with a user device, for example using short-range communication (e.g., near field communication (NFC)) and may communicate information regarding the apparatus to the user device. In some embodiments, the user device may be a mobile unit and may include a mobile application that may perform at least the following functions, in real-time: (a) display the availability and current and historical peak use times of an equipment to the user and the facility manager; (b) enable the user to add themselves to a virtual “waiting or queue” on the app and receive a notification when the equipment is available; (c) suggest alternative equipment and its location when a desired equipment is already in use; (d) capture workout metrics and provide tutorials; (e) enable the user to share his/her location with friends within the facility, etc. For purposes of the present disclosure, “near-field communication” refers to a short-range wireless technology where data is transmitted between two devices in close proximity through electromagnetic fields (i.e., electromagnetic induction).

In some applications, the system may assist a facility manager in using the workout metrics to optimize programming and equipment utilization and to plan for future purchases. In other applications, the system may facilitate the monitoring of the availability of facilities, for example, fitness gyms, exercise studios, study rooms, or other common study areas in a library, dormitory, study hall, or other academic facilities.

The terms “equipment,” “machine,” and “apparatus” may be used interchangeably herein, as well as the terms “user” and “client user.”

### The System

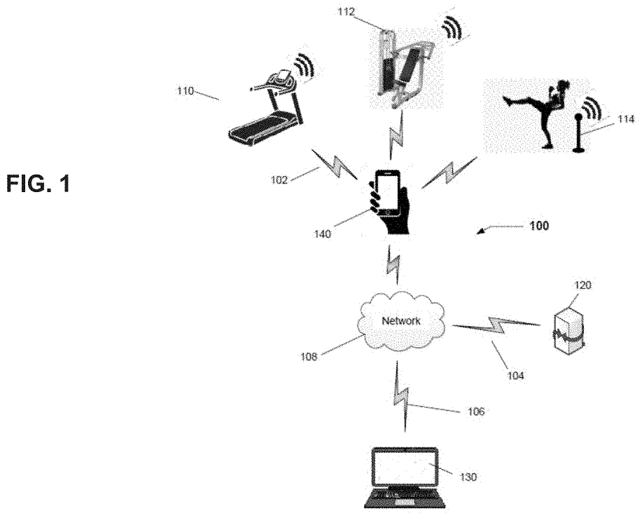

FIGS. 1-19 illustrate examples of various embodiments and implementations of a system for managing the use of exercise facilities, activities, and equipment. FIG. 1 illustrates an example of a system 100 comprising a plurality of exercise apparatuses 110 and 112, a scanning station 114, a booking server 120, and an administrative panel 130. In some implementations, the exercise apparatuses 110 and 112, scanning station 114, and booking server 120 may be networked by wired connection on a local area network (LAN) or by a wireless local area connection (WLAN), wide area network (WAN) via Internet connection, or cloud-based networking. For purposes of the present example, the exercise apparatuses 110 and 112, scanning station 114, and booking server 120 form an exercise activity network via system 100. As used herein, an “exercise activity network” shall refer to the group of client user units, facilities, exercise apparatuses, and exercise activities recorded in a database stored on the booking server.

In the present example, apparatus 110 is a cardio machine (e.g., a treadmill), apparatus 112 is exercise equipment (e.g., a selectorized machine), and scanning station 114 is an NFC circuit or chip positioned near the entranceway, door, or check-in station of an exercise room conducting a fitness class.

While apparatus 112 is depicted in this example as selectorized strength equipment, namely, a selectorized machine, in other implementations, apparatus 112 may include free weight strength equipment or a plate-loaded strength machine.

For purposes of the present disclosure, “selectorized strength equipment” refer to machines that have one or more weight stacks, which are rectangular weight plates that are attached to the frame and utilize a system of pulleys. Users can choose how much weight they wish to lift by inserting a key into the desired weight stack. All the weights above the inserted key will also be lifted and are secured by two rods that run through each of the weights.

For purposes of the present disclosure, “free weight strength equipment” refers to any equipment, such as barbells, dumbbells, and kettlebells, used for weight training that is not attached or otherwise connected to another structural device or external apparatus and is raised and lowered by use of the hands, legs, and arms.

For purposes of the present disclosure, “plate-loaded strength machines” refer to machines that require the use of conventional round plates, the same plates you find on barbells. These plates are hung on the machine.

In some implementations, exercise apparatuses 110 and 112, scanning station 114, and administrative panel 130 may all be located at the same site, such as a gymnasium, fitness center, dormitory, or the like. In other implementations, the administrative panel 130 may be located at a site remote from the exercise apparatuses 110 and 112 and scanning station 114. The booking server 120 may be a cloud-based server computer, located at a remote site.

System 100 may further include a client user device, for example, a mobile unit 140. The mobile unit 140 may be or include a smartphone, iPad, iPod, tablet, digital watch, portable computer, personal digital assistant, or any other suitable mobile device. The mobile unit 140 may communicate with the booking server 120 and the administrative panel 130 (when located remotely) via a wide area network, for example, the Internet.

Users of the mobile unit 140 may include individual people. Additionally or alternatively, users may include other entities, such as facilities managers of recreational facilities, fitness centers, gyms, learning institutions, departments of parks and recreation, or other entities. As disclosed herein, users may use the mobile unit 140 to determine when certain exercise equipment or exercise activities are available at a certain exercise facility. For purposes of the present disclosure, an “exercise facility” may refer to a recreation center, fitness center, gym, weight room, gymnasium, exercise room, dance studio, swimming pool, park, athletic field, or any other athletic facility.

Software, such as a mobile application, may be downloaded or otherwise installed on the mobile unit 140. When a user launches the mobile application installed on the mobile unit 140, a communication 102 may be established between the mobile unit 140 and exercise apparatuses 110 and 112 and scanning station 114, and a user control interface of mobile unit 140 may be enabled to receive user commands from the user. The communication 102 between the mobile unit 140 and exercise apparatuses 110 and 112 and scanning station 114 may be a short-range wireless connection, such as a near-field communication or NFC.

Many exemplary functions herein are described as performed or provided by the mobile application (which may be simply referred to as the application). However, these functions may also be performed by a server computer or a combination of the application and the server computer.

In some implementations, the user control interface may include a touchscreen. In any case, the user can manipulate the user control interface to input or create user commands. In one example, when the user control interface receives a user command, the user command is transmitted to an electronic circuit unit of the mobile unit 140. Thereafter, the electronic circuit unit converts the user command into a booking signal for the user command (the detail of the converting is well-known in the arts and will not be further described herein).

The user control interface may include interactive icons and features with embedded functionality, for example, for viewing YouTube® videos about certain exercise activity, while not requiring the user to switch out of the mobile application 200. The interactive icons with embedded functionality may be implemented in an app, for example, a messaging app. The interactive icons with embedded functionality may also be implemented as a built-in function or built-in application of an operating system, for example, Windows, iOS, IoT, or Android. In an exemplary implementation, an interactive icon with embedded functionality built-in application or function may interface with the mobile application to provide the interactive icons with embedded functionality as described herein.

In some implementations, the exercise apparatus may include an exercise unit and an electronic circuit unit coupled to the exercise unit. The electronic circuit unit may include a hardware, software and firmware assembly which is configured to process each signal according to each corresponding command. For example, the electronic circuit unit may include a microcontroller unit, at least one electronic circuit, and at least one circuit board. A certain program may be read in the microcontroller unit. The microcontroller unit and electronic circuit are assembled on the circuit board to define an assembly. In addition, the assembly is associated with one another, or an electronic device via a wired connection (such as bus wire) or a wireless connection (such as Bluetooth or Wi-Fi). The electric circuit unit is configured to create a status signal which represents the status of the exercise unit. In some implementations, the status of the exercise unit may indicate whether there a user is operating the exercise unit, the identity of the user, the availability of the exercise unit, etc.

In other, preferred, implementations, the exercise apparatus may include an exercise unit and NFC circuit or chip affixed to the exercise unit. The NFC chip (also referred to herein as a “smart tag”) may be configured in the form of a decal or sticker that may be affixed to a piece of exercise equipment or the entrance, doorway, or check-in station of an exercise facility. In some implementations, the smart tags may communicate using the ISO 14443 type A and B wireless standards. The smart tags may be purchased as blank NFC tags where customized data may be written onto them then by, for example, an administrator or facilities manager. A smart tag may be customized with information regarding an exercise apparatus, exercise studio, or activity, including the name of the apparatus or activity, the location of the apparatus or activity, the name of the activity instructor, and a tag ID. Smart tags are generally rewritable but may also be blocked so they can't be overwritten.

Once the mobile application is launched, a smart tag may be energized by magnetic induction when the client user “taps” or otherwise places the mobile unit 140 near the smart tag of an exercise apparatus. When the smart tag is energized, this signals the start of usage (e.g., a workout) of an apparatus or facility, as data is transferred from the smart tag to the mobile unit 140 and, in turn, the mobile application may generate a signal that is transmitted from the mobile unit 140 to the booking server 120 a network connection to notify the system 100, for example, that the exercise equipment is now in use (e.g., “busy”, “checked out”, or “unavailable”).

In other instances, the mobile application may be launched once the smart tag is energized by the mobile unit 140. In these instances, the user does not have to launch the mobile application before checking-in an exercise activity. Instead, the exercise activity will be automatically checked-in when the user places the mobile unit 140 near the smart tag, thus launching the mobile application for use.

In some implementations, the activity or equipment may become “available” again for use once the user either ends their workout at a predetermined time, closes the session by tapping the smart tag with mobile unit 140 and, therefore, “logging it off,” or the system will automatically log the user off after a predetermined period of nonuse of the equipment or activity.

By coupling smart tags to every exercise apparatus, all equipment within a facility may be networked inexpensively, regardless of their model or manufacturer. For example, a Life Fitness™ elliptical may be networked with a Precor™ treadmill. Using smart tags also enables equipment that does not have networking electrical circuits built into the equipment to be networked.

In some implementations, the physical location of each exercise apparatus 110, 112 and scanning station 114 in a facility, and their corresponding serial number, referred to herein as a “tag ID,” may be mapped into the system 100, for example, by an administrator, as described in more detail below. The tag ID may include a series of numbers and/or letter assigned by an administrator to identify a specific piece of equipment, an exercise studio, or facility. The tag ID may be programmed by an administrator into a corresponding smart tag.

Once a user “checks into” or “logs into” an exercise apparatus 110, 112 or scanning station 114, the tag ID of the exercise apparatus or activity is sent from the mobile unit 140 which, in turn, transmits a status signal, generated by the mobile application, to the booking server 120 and the server searches its database, by a computer program or routine, to find data, including the physical location of the exercise apparatus or activity corresponding to the tag ID. Using this data, the location of the client user may be identified by the physical location of the apparatus or facility the user is checked into. For example, if a client user checks-in, for example, treadmill #22, the user's physical location of the device may be determined based on its tag ID and the mapped location of the treadmill. Because the tag ID and the location of each exercise apparatus and activity has been uniquely assigned in the booking server database by an administrator, the booking server 120 may use this data from an activated exercise apparatus or activity to determine the location of a user in a facility.

In addition to tracking the location of a client user using its tag ID, a user's location may be determined by a geographical locator. For example, the mobile unit 140 may continuously broadcast a location identifier to the booking server 120. The location identifier is unique to the mobile device and, further, includes or represents location information of the mobile device relative to a piece of equipment or a station receiving the location identifier.

The booking server 120 may comprise a computer that can be programmed to carry out a set of arithmetic or logical operations automatically. The booking server 120 comprises a database of information relating to each client user, facility, exercise apparatus, and exercise activity in the network. The booking server 120 may communicate with the mobile unit 140 via network connection 104. The network connection 104 may be a public network, such as Internet, cellular-based wireless, Wi-Fi, or cloud-based networking.

In some implementations, when the mobile application of a client user is activated, the mobile application may transmit a status signal and booking signal to the booking server 120 via network connection 104. Thereafter, the booking server 120 may create at least one feedback signal according to the status signal and the booking signal. In some implementations, the status signal and the booking signal may be combined in a single signal. The booking server 120 may then transmit the feedback signal to the mobile unit 140 via the network connection 104. The electronic circuit unit of the mobile unit 140 converts the feedback signal into media content. The media content may include text content, image content, video content, sound content, or the combination thereof. The media content is provided to the user via the user control interface of the mobile unit 140. As described herein, the media content may be displayed in graphical user interfaces, or simply referred to as user interfaces. For purposes of the present disclosure, the “status signal” refers to an electronic signal that contains information about the status of an exercise apparatus or activity, including the tag ID associated with the exercise apparatus or activity. For purposes of the present disclosure, a “booking signal” refers to an electronic signal that contains other information about a facility, exercise apparatus, or activity, such as the name of the facility or activity, the location of the activity or activity, the time of use, and other information.

In some implementations, the administrative panel 130 may comprise a computer with software that allows an administrator (e.g., a facilities manager) to input data into the booking server 120, for example, to name and map the location of equipment, upload and update listings of fitness classes, manage user profiles, and perform other administrative tasks. In particular, an administrator may input information into booking sever 120 regarding an athletic facility, such as, for example, the name of the facility, map the location of the facility, the hours of operation, photographs of the facility, its corresponding tag ID, and other useful data. Similarly, an administrator may input information into booking sever 120 regarding an exercise apparatus, such as, for example, the name of the equipment, the name and tag ID of the facility where the equipment is located (including the floor level of the facility and room number), a description of and information on how to use the equipment, videos and graphics illustrating how to use the equipment, its corresponding tag ID, and other useful data. For exercise activities, an administrator may input information into booking sever 120 regarding the exercise activity, such as, for example, the name of the activity, the name and tag ID of the facility where the activity may be performed (including the floor level of the facility and room number), a description of and information about the activity, the time(s) of the activity, videos and graphics showing the activity, the name and image of the activity instructor, if any, its corresponding tag ID, and other useful data.

Every facility, exercise apparatus, and exercise activity is assigned a tag ID. The booking server 120 uses the tag ID to identify a facility, exercise apparatus, or exercise activity and recall information stored in its database relating thereto. The tag ID of a facility may be linked to every exercise apparatus or exercise activity so the mapped location of the exercise apparatus or exercise activity may be identified by the facility in which the apparatus or activity is located.

If an exercise apparatus or class is moved or relocated, the new location of the equipment or class may be manually re-mapped or otherwise updated in the database of the booking server 120 by an administrator.

In some implementations, a service provider of the mobile application may also access the administrative panel 130 to provide maintenance for the application, upload software updates, and other service administration tasks.

The administrative panel 130 may be electronically coupled to the system 100 via network connection 106. The network connection 106 may be an Internet, Wi-Fi, cellular-based wireless, cloud-based networking, or other wireless connection. In some implementations, through network connection 106, a designated user (e.g., an administrator) may use the administrative panel 130 to access information on the booking server 120 or add or change information, functions, and features of the mobile application.

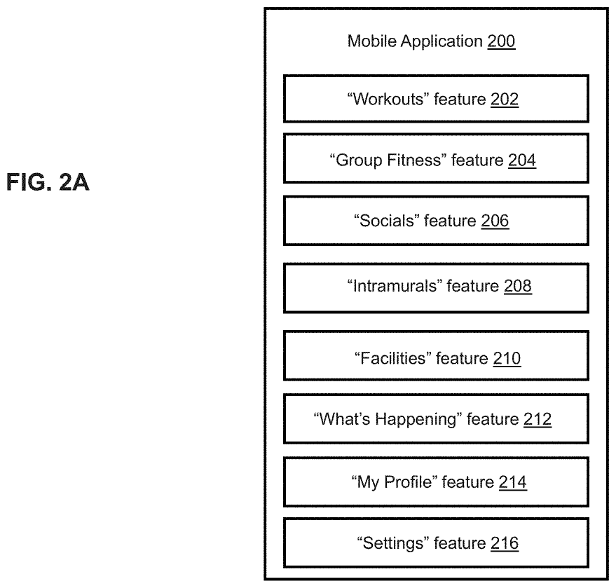

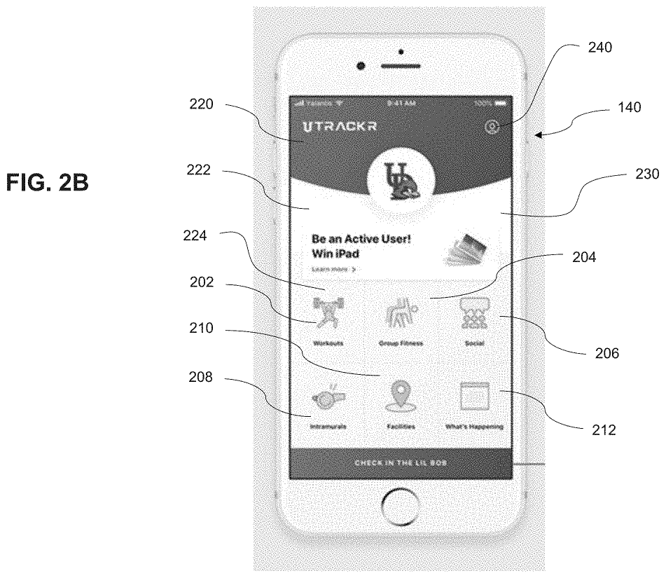

When the client user launches the mobile application on his or her mobile unit 140, the mobile unit 140 may communicate with the booking server 120 via local wireless connection 104. As a result, the user may manipulate the user control interface of the mobile unit 140 (as shown in FIGS. 2-16) to activate features of the application and access data and other information stored on the booking server 120.

### Mobile Application Function and Features

FIG. 2A is a schematic diagram of the exemplary functions and features of a mobile application 200 installed on mobile unit 140, according to the teachings of the disclosure. As shown, the mobile application 200 may include, for example, a “Workouts” feature 202, a “Group Fitness” feature 204, a “Social” feature 206, a “Intramurals” feature 208, a “Facilities” feature 210, a “What's Happening” feature 212, a “My Profile” feature 214, and a “Settings” feature 216. In other implementations, additional functions and features may be provided. Mobile application 200 operates a computing device (i.e., mobile unit 140) that may have one or more operating systems including Windows, Android, iOS or IoT operating system.

FIG. 2B depicts an example of a homepage 220 of mobile application 200 displayed on the user control interface of the mobile unit 140. As shown, the mobile unit 140 includes a touchscreen 220 that can display or provide user interfaces by which the mobile unit receives and/or detects user input. In some implementations, the mobile unit 140 may comprise a touchscreen device with at least one surface upon which a user may perform touch gestures (e.g., laptop, a tablet computer, a personal digital assistant, a media player, a mobile phone). Additionally or alternatively, the mobile unit 140 may include any other suitable input device, such as a touchpad.

FIG. 2B illustrates a graphical user interface (the “GUI”) 222 of the mobile unit touchscreen 220. In this example, the mobile application 200 may include a user interface manager. The user interface manager provides, manages, and/or controls the GUI 222, which displays content and allows the user to activate features of the mobile application 200. For example, the user interface manager may facilitate the display of a user interface composed of a plurality of graphical components, objects, and/or elements that allow a user to activate features of the mobile application 200. More particularly, the user interface manager may direct the mobile unit 140 to display a group of graphical components, objects and/or elements on the GUI 222 that enable a user to activate certain features of the mobile application 200.

As shown, the GUI 222 may display a series of interactive icons 224 or other content corresponding to each feature of the mobile application 200. Each feature may be accessed by touching or otherwise engaging an icon 224 corresponding to the desired application feature. For purposes of the present disclosure, the term “content” will generally refer to text, images, digital media, files, videos, maps, location information, payment information, and other data displayed on the GUI 222.

Turning now to the application 200 functions and features, in some implementations of the Workouts feature 202, the user can access the availability of exercise equipment, view suggested workouts and training, connect data to fitness apps and smartwatches, record workout data, and perform other functions. In some implementations of the Group Fitness feature 204, the user can access a schedule of group exercise classes, reserve class spots, set class reminders and alerts, save information regarding the user's favorite classes and instructors, participate in third-party virtual classes, and perform other functions. In some implementations of the Social feature 206, the user can communicate with friends, find other users with similar interests, connect with fitness trainers and mentors, and perform other functions.

In the Intramurals feature 208, in some implementations, the user can create an intramural team, join a team, input team schedules, message teammates, and perform other functions. In the Facilities feature 210, in some implementations, the user can monitor real-time facility availability (e.g., gym, sports court, sports field, etc.), see “peak” and “best times” for equipment and facility availability, find alternate indoor facilities and equipment, determine the availability of sports fields and other sports facilities, link the user's application programming interface (API) to other gym management systems, and perform other functions. In the What's Happening feature 212, in some implementations, the user may access information about, for example, events and promotions or schedules of athletic teams, and perform other functions. In other implementations, the mobile application 200 may include additional features, such as an “Awards and Badges” feature that records awards obtained by the user for participating in certain exercises or attaining certain personal fitness goals.

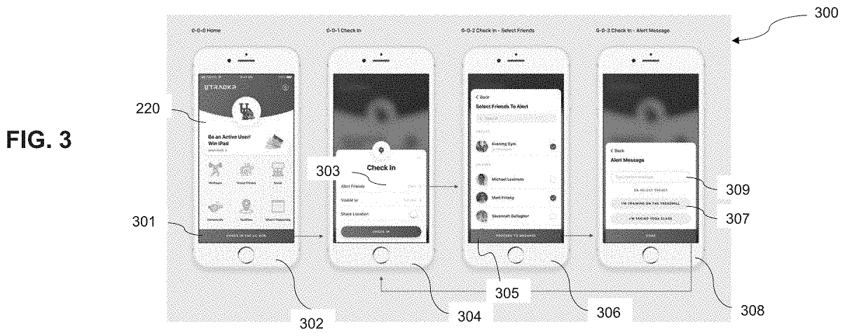

FIG. 3 illustrates how a client user uses the mobile unit 140 to “checks-in” an exercise apparatus. As shown, at 302, the mobile application homepage 220 is displayed when the user initially launches the application. To check-in the apparatus, the user may “tap” the client user device on or place the client user device (e.g., mobile unit 104) near the scanning hub (comprising a smart tag) or, in the alternative, an NFC tag (symbol) affixed to a piece of exercise equipment or scanning station located as an exercise facility. For example, as shown at 302, when the user is near the facility “LIL BOB”, the application indicates at graphic 301 that the user can check in to LIL BOB.

As the “Check-In” page 304 is displayed, e.g., after the user taps the client user device on the smart tag at the scanning station at LIL BOB, the user may select the Alert Friends feature 303, which causes the “Select Friends” page 306 to be displayed. Using this feature, the user may select friends that the system may alert, for example, that the user has checked into LIL BOB, by selecting friends from the friends listing and pressing the “PROCEED TO MESSAGE” text leader 305.

Once the text leader 305 is pressed, the application 200 may then display an “Alert Message” page 308 that allows the user to select a preset alert text 307 or type in an alert text in window 309, to be sent to the selected friends.

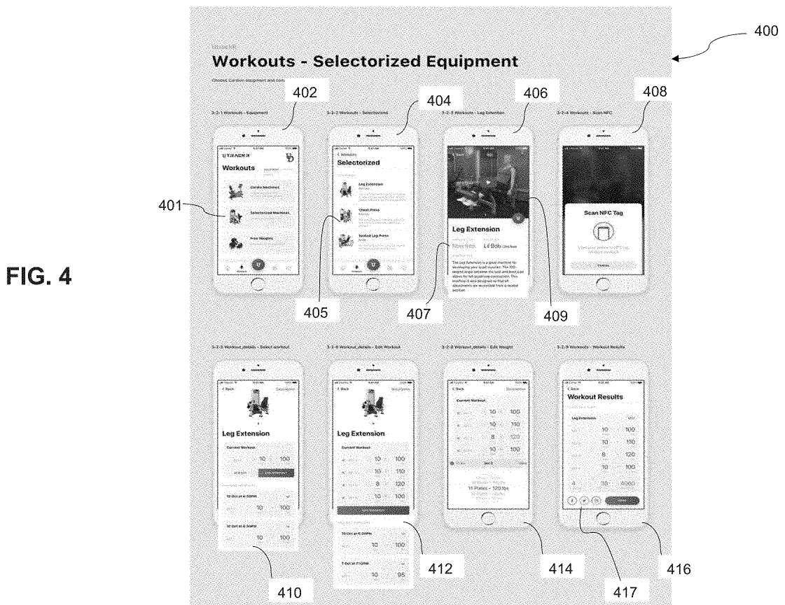

FIG. 4 illustrates an exemplary process 400 by which a user may utilize the Workouts feature 202. In some implementations, after the user selects the Workouts feature 202 (shown in FIG. 2), the application 200 may display an available-equipment display 402 showing a listing of workout equipment available for use. The application 200 may display categorized groups of equipment (e.g., cardio), show individual types of cardio equipment (treadmill, elliptical machines, upright bike, etc.), and how many are currently available. As shown in this example, the user can select “Cardio Machines”, “Selectorized Machines”, or “Weight Machines”. When the user selects, for example, Selectorized Machines feature 401, the application 200 may display a “Selectorized” equipment page 404.

In this example, page 404 provides a listing 405 of selectorized equipment available for use. As shown, the user may select “Leg Extension”, “Chest Press”, or “Seated Leg Press” from the list of available selectorized machines. When the user selects, for example, “Leg Extension” from the listing, the application 200 may display an instructional page 406.

In some implementations, once the user selects a piece of equipment, the instructional page 406 may include text and a media window 409 for displaying instructional videos on how to use the equipment. In some implementations, the media window 409 may deep link and display, for example, instructional videos from YouTube® or other web-based media platforms. The instructional page 406 may also display at 407 the status and location of the equipment. In this example, page 406 shows the Leg Extension equipment as “Now Free” and located at “Lil Bob/2^{nd} Floor”, which may be the nearest available equipment. The application may also instruct the user to go to the nearest available equipment, for example, by using the location identifier of the user device.

Once the user has located the equipment that it desires to use and is near the equipment, the mobile unit 140 and application 200 will detect the smart tag coupled to the equipment and displays a check-in display 408, allowing the user to check in to the equipment. Using the mobile unit 140, the user may scan the smart tag of the selected exercise equipment to “check-in” the equipment.

Once the equipment is checked-in, the application 200 will send a status signal to the booking server 120 and the booking server 120 will update the system 100 to now list the status of the selectorized equipment as, for example, “busy” or “in use.” Thus, subsequent users wish to use the equipment, the user interface will show the status of the equipment as “busy” or “in use” until the user currently using the equipment “check-out” of the equipment.

In some implementations, the system may provide displays 410 to 416 for the user to monitor his or her workout results. As shown, at display 410, the application may display the user's current workout data at the equipment, and a pull-down history. The application may include the ability to add exercise detail, for example, sets of leg extension workouts, etc. The system may then receive data from the equipment and keep the historical data with dated detail, and store in the user profile, e.g., in a database. For example, as shown in display 412 and 414, in Set 1 the user did 10 reps of 100 lbs., in Set 2, 10 reps of 110 lbs. and so on. At display 416, the application may display a total of all sets. By engaging icons 417, a user may post their workout results to third-party social-networking systems, such as Instagram®, Facebook®, or Twitter®.

The messaging and notification between different components can be implemented using API calls, extensible markup language (“XML”) or Javascript Object Notation (“JSON”) config file interfaces between different interfaces, Hypertext Preprocessor (earlier called, Personal Home Page) (“PHP”), Python, Nodejs, Java/C++ object-oriented programming or simple web-based tools.

Different components may also implement authentication and encryption to keep the data and the requests secure. Authentication of a device may be accomplished using public/private key, passwords, token, transaction, biometrics, multi-factor authentication or other methods known in the industry. Encryption may use data encryption standard (DES), TripleDES, RSA, Advanced Encryption Standard (AES) or other methods known in the industry.

In some implementations, the system 100 may also allow users to see historical peak usage times and most available times for each piece of equipment. In these implementations, the application 200 may allow administrators to limit user usage of exercise activities during, for example, “peak use” time. For example, during peak use times, the application 200 may enable an administrator to limit a user's use of an exercise apparatus to thirty minutes. After thirty minutes, the application 200 would send a signal to the booking server 120 to update the exercise apparatus to “free” or “available.”

In other implementations, a user interface may provide a check-out or “done” selection for the user to check-out of the equipment. In the alternative, the equipment may be checked-out by bringing the mobile unit 140 near the scanning station of the equipment to energize the smart tag. In this case, the application 200 may generate a status signal that is transmitted to the booking server 120. Once the user checks-out of the equipment, the booking server 120 will update the status of the equipment to, for example, “free” or “available.” If the equipment is not manually checked out by the user, the equipment may automatically check-out out if the booking server 120 determines that the equipment is no longer in use. For example, if a user schedules to use the equipment for 30 mins, but the equipment is still check-in after 35 minutes of use.

If a user wishes to use a certain type of equipment, for example, a treadmill, but all of the treadmills in the facility are in use, the application 200 may allow the user to add himself or herself to a virtual queue for a certain type of equipment. In this example, the application 200 may notify and direct the user to the next treadmill available for use. This allows users to monitor the availability of fitness equipment in real-time and determine how crowded a fitness facility is.

Similarly, the mobile application may allow a user to monitor the availability of events and classes, e.g., fitness classes. If a fitness class is filled to capacity, the application 200 may notify the user when and where the next class is available and may give the user the ability to register for the class to secure attendance in the class.

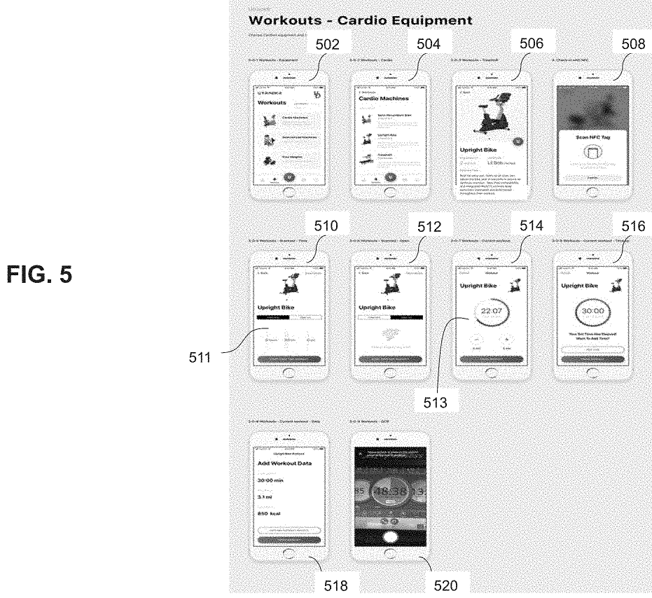

FIG. 5 illustrates another example of the Workouts feature 202 (shown in FIG. 2). In this example, the user selects Cardio Machines in display 502 (also shown in display 402 in FIG. 4). After the user selects Cardio Machines, the application may display an equipment-type display 504, listing various types of available cardio machines. In this example, the display 504 allows the user to select “Upright Bike”, “Semi-recumbent Bike”, or “Treadmill” as the available machines. When the user selects Upright Bike equipment, for example, the application may show display 506. In this example, it shows the Upright Bike equipment as having “2 out of 6” available and located at “Lil Bob/1st Floor”, which may be the nearest available equipment. The application may also instruct the user to go to the nearest available equipment.

In some implementations, once the user has located the equipment and is near the equipment, the mobile unit 140 and application 200 may detect the smart tag coupled to the equipment and display a check-in display 508, allowing the user to check-in the equipment. Using the mobile unit 140, the user may scan the smart tag of the selected exercise equipment to “check-in” the equipment.

Once the equipment is checked-in, the application 200 will send a status signal to the booking server 120 and the booking server 120 will update the system 100 to now list the status of the cardio equipment as, for example, “busy” or “in use.”

In some implementations, the system may provide displays 510 to 516 for the user to monitor his or her workout results. As shown, at display 510, the application 200 may display the user's current workout data at the equipment and rolling history. The application may then receive data from the equipment and keep the historical data with dated detail, and store in a database. For example, as shown in display 510, the application 200 may display an elapsed timing feature 511 to allow the user to set a time counter for the workout and “Start Fixed Time Workout”. At display 512, the application 200 may allow the user to start an open time workout (“Start Open Run Workout”). In this example, the user selects a fixed time run of 30 minutes (at 510). At displays 514 and 516, the application may display a timer 513 and status of the workout. Once the workout is complete, the application 200, as shown at display 518, may display the results of the workout, e.g., “Time Spent” for the workout, “Distance” run, and “Calories” burned. The application 200 may store the results in the user's profile, e.g., in the booking server 120 database. In some implementations, at display 520, the application 200 may also allow users to recall historical workout data.

In some implementations, the user interface may provide a check-out or “done” selection for the user to check-out of the equipment, facility, or exercise class. In the alternative, the equipment may be checked-out by bringing the mobile unit 140 near the scanning station of the equipment to energize the smart tag. In their case, the application 200 may send a status signal to the booking server. Once the user checks-out of the equipment, facility, or exercise class, the booking server 120 will update the status of the equipment, facility, or exercise class to, for example, “free” or “available.” If the equipment is not manually checked out by the user, the equipment may automatically check-out out if the booking server 120 determines that the equipment is no longer in use.

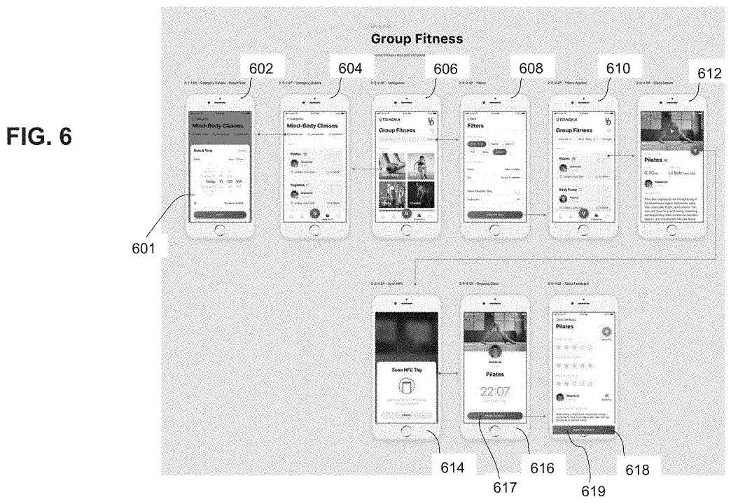

FIG. 6 illustrates an example of the Group Fitness feature 204 (shown in FIG. 2). At display 606, the application may display a listing of available Group Fitness categories, e.g., “Mind-Body”, “HIT”, “Cardio” and “Dance” for the user to select. In this example, when the user selects the “Mind-Body” category, the application may show display 604, showing what exercises in this category are available and their details, e.g., types (Pilates, Yogilates, etc.) are shown in display 604, including, for example, the name of the instructor of the exercise activity, and the date, time, and location of the class. When the user selects, for example, “Date & Time” feature, as shown at display 602, the application 200 may display an interactive digital calendar 601 where the user may scroll through available date and time slots.

In some instances, a user may desire to search for fitness classes according to the types of classes (e.g., yoga classes). This may be accomplished using a Filter sub-feature of the Group Fitness feature 204. In some implementations, when the user selects the Filters feature at display 608, the application 200 may show display 608, which allow the user to more efficiently select for exercise activities by category, type, instructor, date and time, and location, among other parameters, without going through multiple user interfaces. In this example, from display 608 filters, the application 200 receives and determines what the user wants, and displays the matched classes (e.g., “Pilates” and “Body Pump”) in display 610. The user may then select a class, e.g., “Pilates” as shown in display 612.

Once the user selects a class, the application 200 may provide a video (at 612) showing a preview of the class or instructions. The application 200 may also instruct the user to attend the class.

In some implementations, once the user has located the equipment and is near the equipment, the mobile unit 140 and application 200 may detect the smart tag coupled to the equipment and display a check-in display 614, allowing the user to check in to the class. By scanning the smart tag at the scanning station, the mobile unit 140 may check the user into the class.

Once the user checks into a class, the application 200 will send a status signal to the booking server 120 and the booking server 120 will update the system 100 to now list the user as, for example, “attending class.” The system 100 may, further, update the number of attendees in the class, and the number of remaining available spaces. The application 200 may show display 616, showing the user in the class and the time remaining in the class session. When the user completes the class, the user may select the “FINISH WORKOUT” text leader 617, which may cause the application to display an evaluation page at display 618. There, the user may post an evaluation about the class, by rating the class and posting the rating via the “SUBMIT FEEDBACK” text leader 619 but selecting feedback about

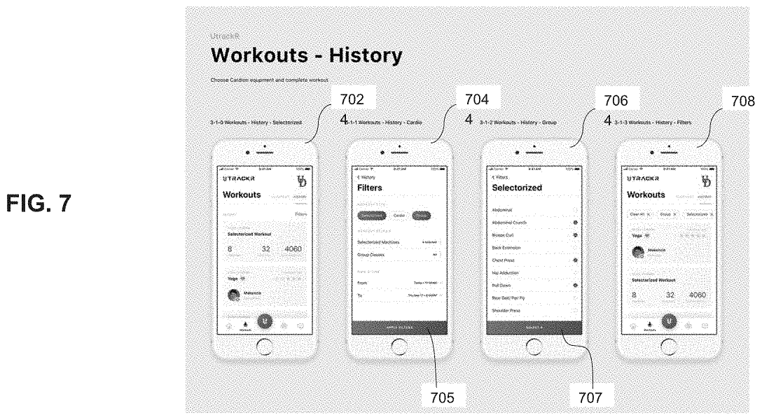

FIG. 7 illustrates an example of the Workouts History feature. In some implementations, the system 100 may store all workout data of the user in their user profile. For example, display 702 displays the selectorized workout history saved in a user profile. Displays 704 and 706 provide filters the user can use to select more specific desired workout histories (e.g., equipment, workout, etc.). For example, the user may filter their past workout history by type of equipment and group, and by selecting an “APPLY FILTERS” text leader 705, a list of prior workouts may be listed, as shown at display 706. Once the workout histories of certain exercise activities are selected at display 706, a count of the number of workout histories selected will appear at text leader 707 (e.g. “SELECT 4”) along the bottom of display 706. By selecting text leader 707, the application 200 may show display 708, which displays the results of the prior exercise activities selected.

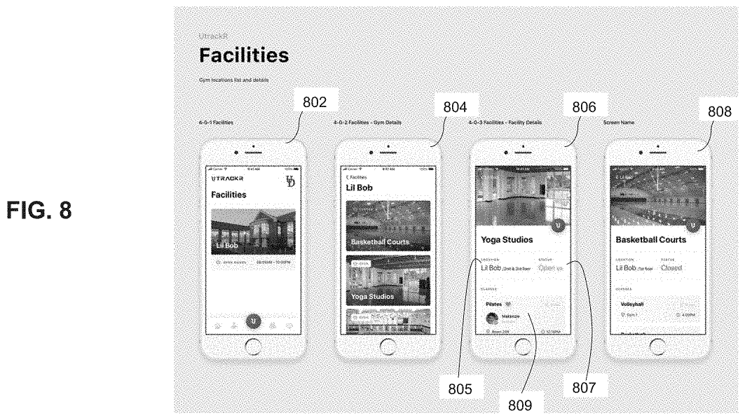

FIG. 8 illustrates an example of the Facilities feature 210 (shown in FIG. 2). Generally, the application may provide the ability for users to view images and check the availability of a facility, for example, a gym, studio, or fitness facility. When a user selects the Facilities feature 210, the application 200 may show display 802. Display 802 may list or otherwise display the available facilities and their open/close status. When the user selects a facility, for example, “Lil Bob”, the application 200 may display further details about the facility. As shown, for example, display 804 displays photo images of various locations of the “Lil Bob” facility, such as its “Basketball Courts” and “Yoga Studios.” When a user selects an image, the application 200 may provide additional information about the status of the facility. For example, the application 200 may show display 806, which provides information about the facility, for example, its location, status, capacity, classes, and other information. In the example shown, the application 200 may display a location field 805 (e.g., in “Lil Bob/2^{nd} & 3^{rd} floor”), the status field 807 (e.g., “Open”), and class field 809 (e.g., “Pilates”). In another example, shown at display 808, the application 200 indicates that the Basketball Court in “Lil Bob/1^{st} floor” is Closed, and the classes available at the facility include, Volleyball at Gym 1 at 4:00 pm.

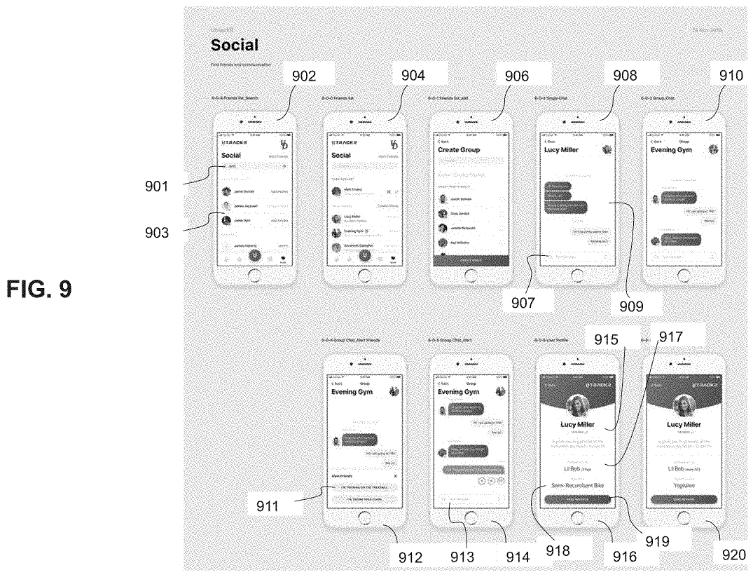

FIG. 9 illustrates an example of the Social feature 206 (shown in FIG. 2). Generally, the application 200 may provide the ability for users to connect and communicate with other users individually as well as in a group. As shown, a user can message other users, create a fitness group for exchanging fitness data, and posting personal content, for example, information about a group class, a workout, or workout results.

When a user selects the Social feature 206, application 200 may show display 902 containing a text field 901 where the user may type in the name of other users to add to a friends list. The search field 901 also includes a user listing 903 where the client user may click on text (e.g., “ADD FRIENDS”) to add other users to their friends list. The user listing 903 further lists friends with pending friend invitations.

Display 904 illustrates an example of a Friends List sub-feature of the Social feature 206. Display 904 includes a “NEW REQUEST” section, where the client user may receive friend requests from other users, and a “YOUR FRIENDS” section, comprising a listing of the client user's friends. In the NEW REQUEST section, the user may accept a friend request by clicking, for example, the “√” symbol, or reject the friend request by clicking the “X” symbol. At display 904, the user may create a “group” listing for friends by clicking on the “CREATE GROUP” text in the YOUR FRIENDS section. By clicking on the “CREATE GROUP” text, the application 200 may show display 906, which allows the user to select one or more persons of the user's Friends List to create a group.

The Social feature 206 also includes a text messaging function. Display 908 is an example of a messaging interface of the application 200, comprising a text input field 907, where the user may input alphanumeric text, symbols, and emojis, and a messaging field 909 that displays the messaging communications between the client user and other users. Display 908 illustrates an example of a one-on-one chat between the client user and an individual friend. Display 910 illustrates an example of a “group” chat between the user and a group of friends.

An additional function of the Social feature 206 is an alert function. In some implementations, as shown in display 912, the application 200 may allow the user to create alerts to notify friends. For example, the user can select a pre-transcribed text alert 911 to let friends know that “I'M TRAINING ON THE TREADMILL”, or “I'M TAKING YOGA CLASS”. Or, as shown in display 914, the user can transcribe an alert in a text input field 913.

In some implementations, a user may search through their friends list and the application 200 may display the status and current activity of each friend. Display 916 comprises a friends ID window 915 that identifies the name of the other user, a location section 917 that identifies the location of the other user, and an activity section 918 that identifies the exercise activity that the other user is currently engaged in. In this example, display 916 shows that friend Lucy Miller is currently active and doing Semi-Recumbent Bike on the 2^{nd} floor of the Lil Bob facility. In another example, display 918 shows that friend Lucy Miller is currently active and doing Yogilates in Lil Bob, Room 203. Once a friend has been selected by the user, the client user may send the friend a text message by selecting SEND MESSAGE 919.

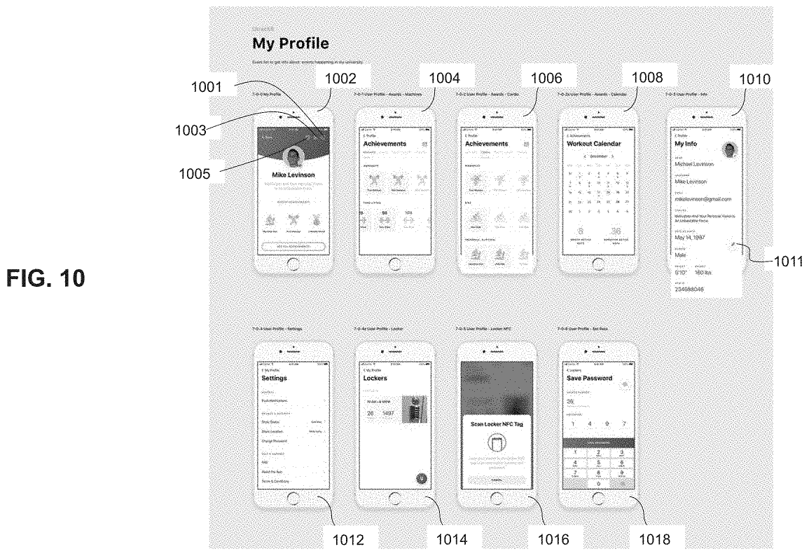

An additional feature of the application 200 allows users to create and store user profile data in the booking server 120 database. FIG. 10 illustrates an example of a “My Profile” feature of the application 200. A user may access this feature by selecting a user profile icon 240 (see FIG. 2B) in the upper left-hand corner of homepage 220. Generally, the application 200 may allow the users to enter their personal information, view fitness awards and achievements, set a workout calendar, change user settings, set passcodes, other information. The application 200 may also provide the users with certain incentives, such as awards and merit badges, based on their successful completion of certain fitness activities. This may incentivize users to meet certain fitness goals.

As shown, display 1002 depicts a main page of a user profile. The main page may display the client user's name, an image of the user, and recent exercise goals and awards recently achieved by the user. If the user selects panel 1003, the application 200 may show display 1004 and 1006, which identifies various goals and achievements obtained by the user. Display 1008 displays a workout calendar that shows, for example, the user's workout calendar and dates when certain fitness awards and achievements were received by the user.

By clicking the info icon 1001 on the user profile main page, the application 200 may display display 1010. Unser interface 1010 is a My Info function that allows the user to enter and store persona information about the user, including the user's name, username, email address, personal tagline, date of birth, gender, height, weight, and user identification number. By clicking an edit icon 1011, the user may enter and edit their personal information.

By pressing icon 1005, display 1012 allows the user to change their account settings, such as the user's alert settings, privacy and security settings (e.g., show status setting, share location settings, and change password settings), and help and support settings. In the help and support settings, the user may find answers to frequently asked questions, obtain more information about the mobile application, and access the mobile application terms of use.

In some implementations, the My Profile may, further, include an electronic locker function. As shown in display 1016, when the mobile unit 140 is brought near an electronic or “smart” locker, the mobile unit 140 and application 200 may detect the smart tag coupled to the locker. Once the user has stored their clothes in the locker, the user may scan the smart tag coupled to the locker to lock the locker. After the user completes their workout, the user may, once again, scan the smart tag coupled to the locker to unlock the locker. By scanning the smart tag at the scanning station, the mobile unit 140 may check the user into the class.

By pressing icon 1003, display 1014 also displays other information for the locker, e.g., locker location, locker number, locker passcode/password, etc. Display 1018 allows the user the ability to change and save the passcode/password to the electronic locker.

### Logic Charts for Mobile App Features

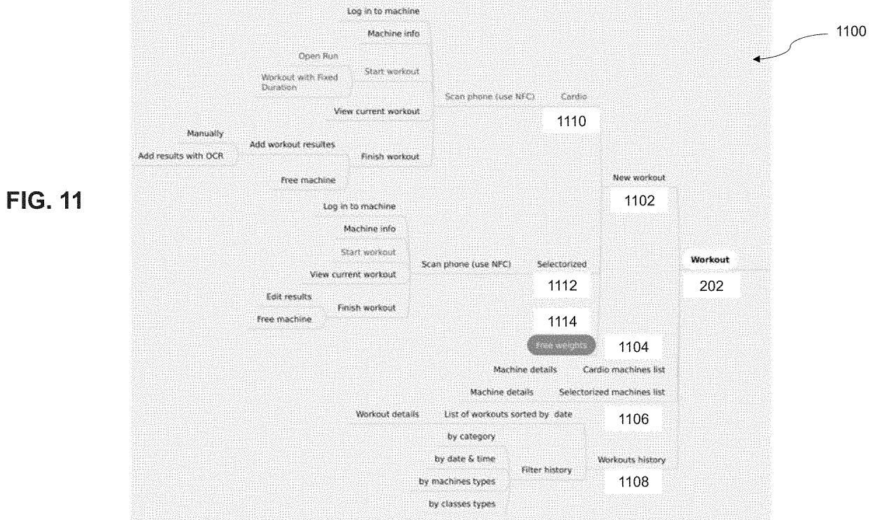

FIGS. 11 to 16 illustrate examples of high-level logic charts for the various mobile application 200 features. For example, FIG. 11 illustrates an example logic chart 1100 for the Workouts feature 202. As shown, the Workouts feature 202 may include a New Workout sub-feature 1102, a Cardio Machines List sub-feature 1104, a selector's eyes machine List sub-feature 1106, and a Workouts History sub-feature 1108.

When a user selects the New Workout sub-feature 1102, the user will be prompted to select between a Cardio Equipment sub-feature 1110, a Selectorized Equipment sub-feature 1112, and a Free Weights sub-feature 1114.

The Cardio Equipment sub-feature 1110 enables a user to search only for cardio machines without having to access the entire list of available equipment and activities. If the user selects the Cardio Equipment sub-feature 1110, the user will be prompted to scan an NFC tag affixed to an exercise apparatus (e.g., a treadmill) with their mobile unit 140. Once the user scans the NFC tag, the user will be logged into the machine and information regarding the exercise apparatus will be transmitted to the mobile unit 140, and the user will then be permitted to begin their workout. The user will be able to use the exercise apparatus for an “open” or unlimited amount of time, or, in the alternative, the user can set their workout on the exercise apparatus for a fixed duration of time. During the workout, the mobile application 200 tracts and records data for the current workout including, for example, the elapsed time of the workout, and the amount of calories burned by the user during the workout. In some implementation, the mobile application 200 may be synchronized with the exercise apparatus through the network, such that real-time data from the exercise apparatus is

Once the user has completed their workout on a cardio machine, either by scanning the smart tag to check-out the machine or, by elapsed time, the results of the workout will be saved in the mobile application 200.

The Selectorized Equipment sub-feature 1112 enables a user to search only for selectorized machines without having to access the entire list of available equipment and activities. If the user selects the Selectorized Equipment sub-feature 1112, the user will be prompted to scan an NFC tag affixed to an exercise apparatus (e.g., a lateral delt raise machine) with their mobile unit 140. Once the user scans the NFC tag, the user will be logged into the machine and information regarding the exercise apparatus will be transmitted to the mobile unit 140, and the user will be permitted to begin their workout. During the workout, the mobile application 200 tracts and records data for the current workout including, for example, the number of sets completed, the number of exercise repetitions per set, the amount of weight lifted during each set, and an estimated amount of calories burned by the user during the workout.

Once the user has completed their workout on the selectorized machine, the user may scan the NFC tag to check-out of the exercise apparatus and the results of the workout will be saved in the mobile application 200. Once saved, the user will further be permitted to edit the workout results.

The Free Weights sub-feature 1114 enables a user to search only for free weight equipment without having to access the entire list of available equipment and activities. If the user selects the Free Weights sub-feature 1114, the user will be prompted to scan an NFC tag affixed to an exercise apparatus (e.g., a weight bench) with their mobile unit 140. Once the user scans the NFC tag, the user will be logged into the machine and information regarding the exercise apparatus will be transmitted to the mobile unit 140, and the user will be permitted to begin their workout. During the workout, the will be permitted to record information regarding the current workout including, for example, the number of sets completed, the number of exercise repetitions per set, and the amount of weight lifted during each set.

Once the user has completed their workout on the free weight machine, the user may scan the NFC tag to check-out of the exercise apparatus and any results recorded by the user concerning the workout will be saved in the mobile application 200. Once saved, the user will further be permitted to edit the workout results.

As further shown, when a user selects the Cardio Machines List sub-feature 1104, a listing of cardio machines in the network is displayed on the GUI 222, including details about machines such as the location and other information about each individual machine. When a user selects the Selectorized Machines List sub-feature 1106, a listing of selectorized machines in the network is displayed on the GUI 222, including details about the machines such as the location and other information about each individual machine.

The Workouts History sub-feature 1108 allows a user to recall information about their previous workouts. If the user selects the Workouts History sub-feature 1108, a listing of the user's past recorded workouts will be displayed on the GUI 222, sorted by date and times. The user may then activate the touchscreen by touching an icon corresponding to one of the listed workouts and, once engaged, detailed information about the listed workout will be displayed on the GUI 222. The Workouts History sub-feature 1108 further includes a workout history filter function, where the user may search for past workouts by category, time and date, machine type, or by exercise class type.

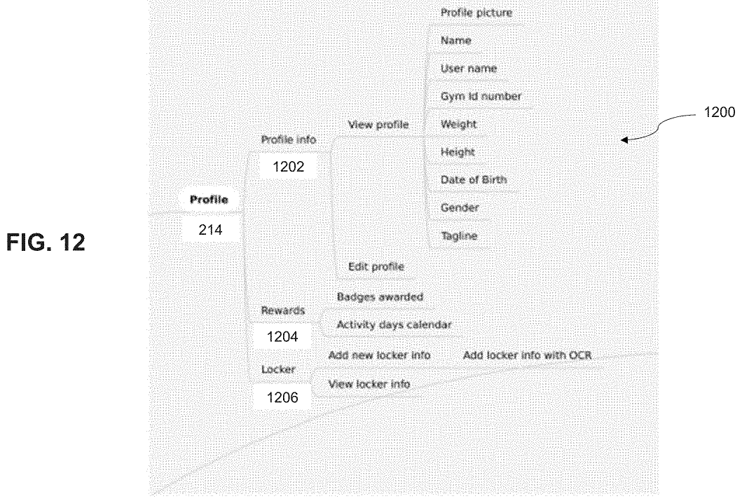

FIG. 12 illustrates an example logic chart 1200 for the My Profile feature 214. As shown, the My Profile feature 214 may include a User Profile Info sub-feature 1202, a Rewards sub-feature 1204, and a locker 1206 sub-feature. When a user selects the User Profile Info sub-feature 1202, the user may view profile information corresponding to the user such as a profile picture, the user's name, a user name, a gym ID number, the user's weight, the user's height, the user's date of birth, the user's gender, and a user tag line. The User Profile Info sub-feature 1202 includes an edit profile function that allows the user to input, edit and/or save the user's respective profile information.

When a user selects the Rewards sub-feature 1204, the user may view activity badges awarded to the user based upon reaching certain exercise milestones. This sub-feature also includes a daily activity calendar of exercises and workouts to be completed by the user. The daily activity calendar is populated with exercise activities that the user is scheduled to complete.

When a user selects the Locker sub-feature 1206, the user may use the mobile unit 104 to lock or unlock an electronic locker coupled to an NFC scanning station. Using this feature, the user may add a new electronic locker to their user profile by scanning the NFC tag coupled to the electronic locker. This feature may include an add new locker feature that enables the mobile application 200 to download and store information corresponding to the newly added electronic locker. A new electronic locker may also be added to the user's profile by scanning and OCR code coupled to the newly added electronic locker. Under this feature, a listing of the electronic lockers stored in the user's profile may be displayed on the GUI 222 and once the user engages an icon corresponding to an electronic locker, information about the locker, such as the location of the locker in its locker ID, may be displayed on the GUI 222.

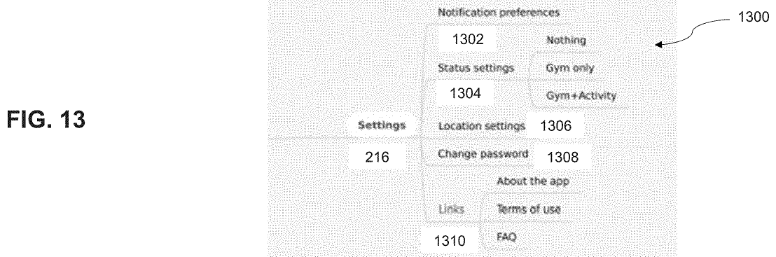

FIG. 13 illustrates an example logic chart 1300 for the Settings feature 216. As shown, the Settings feature 216 may include a Notification Preferences setting 1302, a Status setting 1304, a Location setting 1306, a Change Password setting 1308, and a Links setting 1310. When a user selects the Notification Preferences setting 1302, the user may change the mobile application push notification settings. For example, the user may select a setting that causes the mobile unit 140 to vibrate when a notification is sent to the user.

The Status Settings sub-feature 1304 is a default visibility setting that allows the user to change who can view the user's profile and status. For example, the user may permit “Everyone” to view their profile and status. Or, in the alternative, the user may restrict permission to only “Friends” or “Private.” The Private setting still allows the system 100 to see and track a user's status and register their activity. This setting just does not allow other users to access a client user's profile information.

When a user selects the Location setting 1306, the user may turn on or turn off the mobile unit's 140 global positioning systems (GPS) or location services feature. This setting allows the mobile application 200 to gather and use information based on the current geographical location of the mobile unit 140.

When a user selects the Change Password settings 1308, the user is permitted to change the user password. In particular, when this setting is selected, a text input field is displayed on the GUI 222 for entering the old password, and a new desired password. In the Links setting 1310, the user can obtain information about the mobile application 200, can view the terms of use, or obtain help on how to use the mobile application via a FAQ feature.

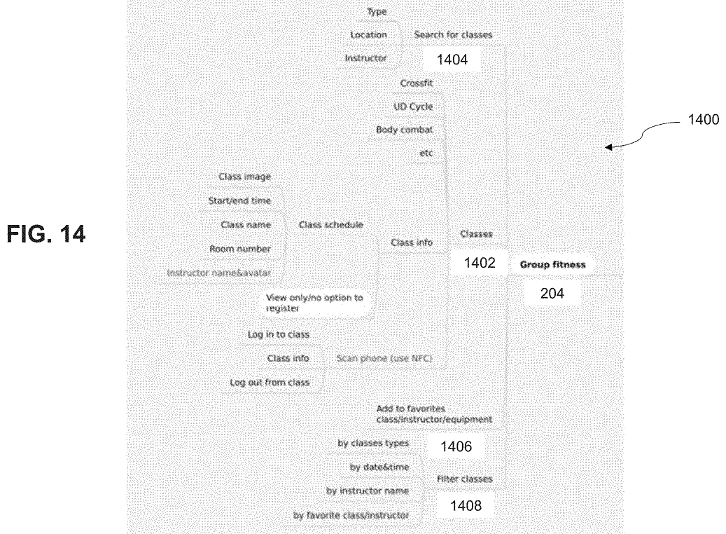

FIG. 14 illustrates an example logic chart 1400 for the Group Fitness feature 204. As shown, the Group Fitness feature 204 may include a Classes sub-feature 1402, a Search for Classes sub-feature 1404, a Favorites sub-feature 1406, and a Filter Classes sub-feature 1408. When a user selects the Classes sub-feature 1402, the user may obtain information about a particular exercise class, such as the class schedule, photos, images, or a description of the class, the class name, the room number, and the name of the instructor. In some instances, a photo image or avatar may be displayed next to the name of the instructor.

In the Classes sub-feature 1402, the user may also be prompted to scan, with their mobile unit 140, an NFC tag affixed to an apparatus at the exercise classroom. Once the user scans the NFC tag, the user will be checked into the class, the NFC tag will transmit information about the fitness class to the mobile unit 140, and the user will be permitted to begin the class. Once the user has completed the class, the user may scan the NFC tag to check-out of the class and the class will be saved in the mobile application 200 as part of the user's workout history.

In the Search for Classes sub-feature 1404, the user may search for a fitness class based on the type of class, the geographic location of the class, or class instructor. In the Favorites sub-feature 1406, the user may add fitness classes to their favorites listing. In this feature, instead of using the Classes sub-feature 1402, or the Search for Classes sub-feature 1404, a user may access information about fitness classes that the user regularly attends.

In the Filter Classes sub-feature 1406, the user may filter a listing of fitness classes to group them by class type, dates and times, instructor name, or by favorite class or instructor.

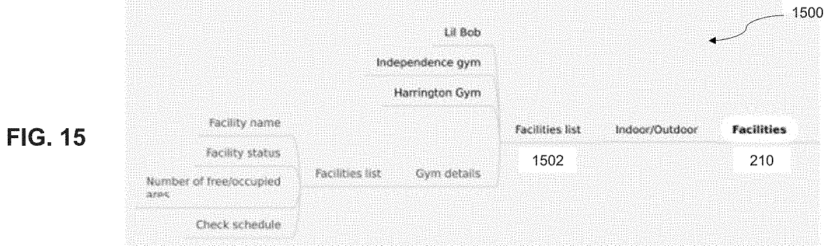

FIG. 15 illustrates an example logic chart 1500 for the Facilities feature 210. As shown, the Facilities feature 210 permits the user to access a list of exercise facilities that may be grouped by indoor facilities or outdoor facilities. Once an exercise facility is selected, details about the facility may be displayed on the GUI 222, such as the facility name, images of the facility, hours of operation, the facility status (i.e., is it open or closed), the location of the facility, the types of activities performed at the facility, and reservation schedule.

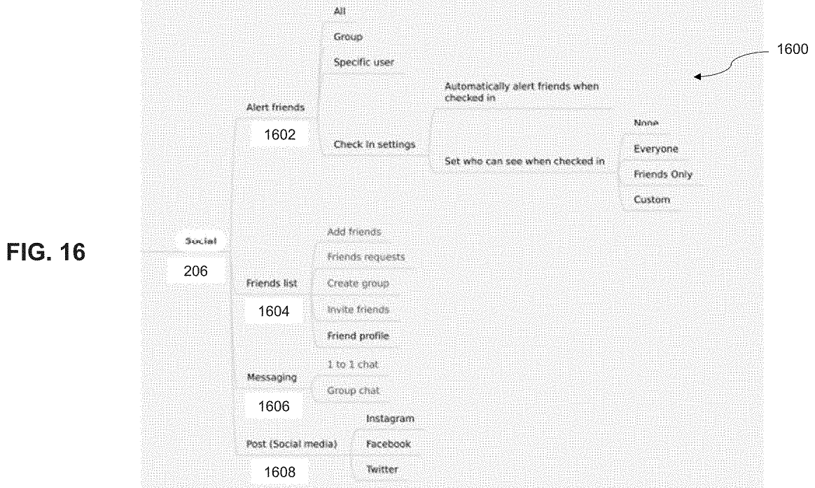

FIG. 16 illustrates an example logic chart 1600 of the Socials feature 206. As shown, the Socials feature 206 may include an Alert Friends sub-feature 1602, a Friends List sub-feature 1604, a Messaging sub-feature 1606, and a Post (Social Media) sub-feature 1608. When a user selects the Alert Friends sub-feature 1602, the user may send alerts, comprised of messages composed by the user, all users listed in the user's Friends list, to a group of users listed in the user's friend list, or only to a specific user. The Alert Friends sub-feature 1602 includes a check-in setting where a notification may automatically be sent to alert friends when the user checks-in to a particular exercise apparatus or fitness class. The setting allows the user to limit who the notification may be sent to when the user checks in to a particular exercise apparatus or fitness class. In particular, the user may disable the notification or enable the notification to be sent to all users on the network, only to friends, or particular users.

In the Friends List sub-feature 1604, the user may be able to add other users to their Friends list, respond to a request or invitation from other users to be added to a Friends list, create a Group list from users in the Friends list, invite other users to join a Friends list, and create a friend profile. In the Messaging sub-feature 1604, a text input field, along with an alphanumeric keyboard, may be displayed on the GUI 222 to permit the user to compose and send text messages to another user in a one-to-one chat, or to a group of other users in a group chat.

In the Post (Social Media) subfeature 1608, the user may be permitted to access third-party social-networking systems, such as Instagram®, Facebook®, or Twitter®, to post content (e.g., videos of a yoga class) or communicate with persons outside of the network. A social-networking system may enable its users (such as persons or organizations) to interact with the system and with each other. The social-networking system may, with input from a user, create and store and the social-networking system a user profile associated with the user. The user profile may include demographic information, communication-channel information, and information on the personal interests of the user. The social-networking system may also, with input from a user, create and store a record of relationships of the user with other users of the social-networking system, as well as provide services (e.g., wall post, photo-sharing, online calendars and event organization, messaging, games, or advertisements) to facilitate social interaction between or among users. Also, the social-networking system may allow users to post photographs and other multimedia content items to a user profile page (typically known as “wall post” or “timeline post”) or in a photo album, both of which may be accessible to other users of the social networking system depending upon the user's configured privacy settings.

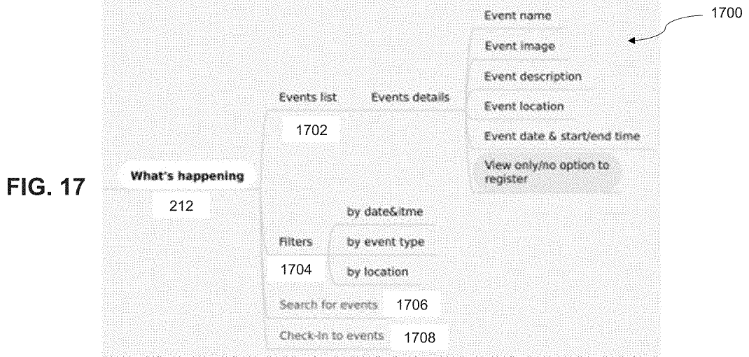

FIG. 17 illustrates an example logic chart 1700 of the What's Happening feature 212. The What's Happening feature 212 provides information about local events and activities taking place in the geographic area of the user. As shown, the What's Happening feature 212 may include an Events List sub-feature 1702, a Filters sub-feature 1704, a Search of Events sub-feature 1706, and a Check-In to Events sub-feature 1708.

When a user selects the Events List sub-feature 1702, a listing of local activities and the events are displayed on the GUI 222. The user may select a listed event to obtain information about the event or activity including, for example, the event name, images of the event, a description of the event, the location of the event, the date of the event, and the start and in time of the event. In the Filters sub-feature 1704, local activities and events may be listed and grouped, for example, by date and time, event type, or geographical location. In the Search of Events sub-feature 1706, the user may search for certain activities or events, and in the Check-In to Events sub-feature 1708, the user may check-in to an event by scanning an NFC tag at a scanning station located at the event.

### Use Management

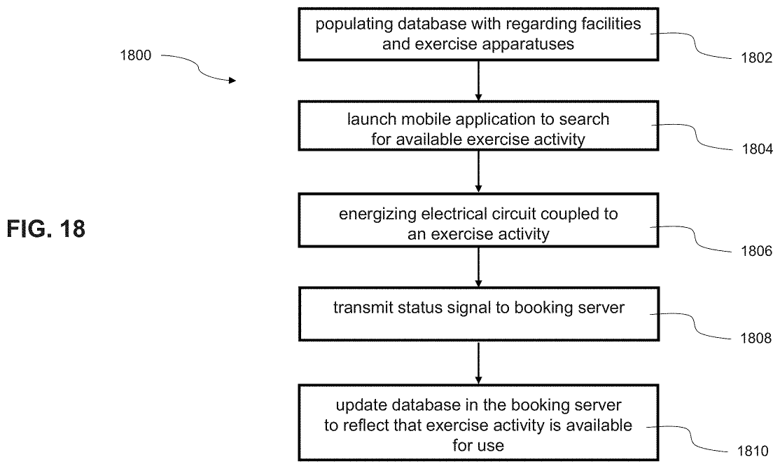

FIG. 18 illustrates a flow chart of a method 1800 of managing the use of exercise equipment according to the teachings of the present disclosure. The method 1800 includes an act 1802 of populating a database stored on a computing device with information concerning one or more exercise activities. The information entered for each facility into the database may include the name of the facility, the geographic location of the facility, the times of operation, and a tag ID number. This information may be input and stored in the booking server 120 by an administrator through the administrator panel 130. Similarly, information regarding each exercise apparatus located at an exercise facility, including the name of the apparatus, the geographic location of the apparatus, and a tag ID number associated with the apparatus, may be input and stored in the booking server 120 by an administrator through the administrator panel 130. In addition to information regarding a facility or exercise apparatus, the administrator may also input additional information or content into the booking server 120 concerning a facility or exercise apparatus, such as photographs, images, instructional information, and videos showing how to use the apparatus.

The method 1800 also includes an act 1804 of launching a mobile application 200 on its mobile unit 140 to see what exercise activities are available when the user desires to engage in an exercise activity (e.g., use an exercise apparatus or attend a fitness class). When the user launches the mobile application 200, the mobile application 200 communicates with the booking server 120 via wireless connection 104 to obtain information about available exercise activities. The mobile application 200 enables the user to search through a listing of available exercise activities by name, location, type, or, additionally, for fitness classes, by the name of the instructor conducting the class.

The method 1800 also includes an act 1806 of using the mobile application to check-in an exercise activity when the user begins to engage in the activity. For example, the user may check-in an exercise apparatus by bringing the mobile unit 140 near a scanning station affixed to the exercise apparatus. Once the mobile unit 140 is brought into proximity to the smart tag comprising the scanning station, the mobile unit 140 will energize or activate the smart tag and the smart tag will transmit data to the mobile unit 140 concerning the apparatus, namely the name of the apparatus, the type of apparatus, and the smart tag ID.

The method 1800 further includes an act 1808 of, once the mobile unit 140 receives the data from the smart tag, the application 200 sending data, along with a status signal to the booking server 120 to notify the booking server 120 that the exercise activity corresponding to the smart tag ID is currently in use.

The method 1800 further includes an act 1810 of the booking server 120 updating its database to identify that a particular exercise apparatus as being in use.

In some implementations, the method 1800 may further include an act of the mobile unit 140, through mobile application 200, locally storing other information regarding the exercise apparatus, such as the name of the apparatus used, the date in which the apparatus was used, and the length of time that the apparatus was used, calories that were exerted by the user, and other information. This information may be backed up in the booking server 120 under the user's profile.

In other implementations, the method 1800 may further include an act of checking-out of the exercise activity after the activity has been completed. In this act, once the user has completed their exercise activity, the user may check-out of the exercise activity by, once again, bringing the mobile unit 140 near the scanning station coupled to the exercise activity to activate the smart tag. Once the smart tag is activated a second time, the mobile application 200 will send a status signal to the booking server 120 letting the booking server 120 know that the exercise activity connected with the smart tag ID has been checked-out and is now available for use.

In other implementations, the method 1800 may further include an act of updating the database in the booking server 120 to reflect that the exercise activity connected to the smart tag ID is now available for use. As mentioned above, information regarding a user's completed exercise activity may then be stored on the mobile unit 140 and/or backed-up on the booking server 120.

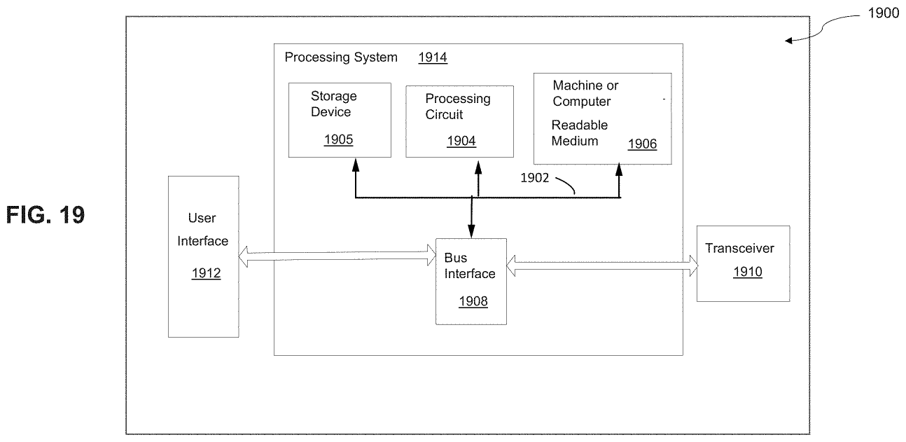

FIG. 19 illustrates an exemplary overall platform (e.g., server, device, etc.) 1900 in which various embodiments, implementations and process steps disclosed herein can be implemented. In accordance with various aspects of the disclosure, an element (for example, a host machine or a microgrid controller), or any portion of an element, or any combination of elements may be implemented with a processing system 1914 that includes one or more processing circuits 1804. Processing circuits 1904 may include micro-processing circuits, microcontrollers, digital signal processing circuits (DSPs), field-programmable gate arrays (FPGAs), programmable logic devices (PLDs), state machines, gated logic, discrete hardware circuits, and other suitable hardware configured to perform the various functionalities described throughout this disclosure. That is, the processing circuit 1904 may be used to implement any one or more of the various embodiments, systems, algorithms, and processes described above. In some embodiments, the processing system 1914 may be implemented in a server. The server may be local or remote, for example in a cloud architecture.

In the example of FIG. 19, the processing system 1914 may be implemented with a bus architecture, represented generally by the bus 1902. The bus 1902 may include any number of interconnecting buses and bridges depending on the specific application of the processing system 1914 and the overall design constraints. The bus 1902 may link various circuits including one or more processing circuits (represented generally by the processing circuit 1904), the storage device 1905, and a machine-readable, processor-readable, processing circuit-readable or computer-readable media (represented generally by a non-transitory machine-readable medium 1906). The bus 1902 may also link various other circuits such as timing sources, peripherals, voltage regulators, and power management circuits, which are well known in the art, and therefore, will not be described any further. The bus interface 1908 may provide an interface between bus 1902 and a transceiver 1910. The transceiver 1910 may provide a means for communicating with various other apparatus over a transmission medium. Depending upon the nature of the apparatus, display 1912 (e.g., keypad, display, speaker, microphone, touchscreen, motion sensor) may also be provided.

The processing circuit 1904 may be responsible for managing the bus 1902 and for general processing, including the execution of software stored on the machine-readable medium 1906. The software, when executed by processing circuit 1904, causes processing system 1914 to perform the various functions described herein for any apparatus. Machine-readable medium 1906 may also be used for storing data that is manipulated by processing circuit 1904 when executing software.

One or more processing circuits 1904 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The embodiments of the present disclosure reflect an inventive concept in the arrangements and combination of the devices, components and method steps utilized in equipment management and utilization. The embodiments of the present disclosure also provide for improvements over prior modes in the field of equipment management and utilization. These improvements can include, for example, optimization of computer resources, improved data accuracy and improved data integrity, to name only a few. In a number of embodiments and implementations, instructions stored in the memory of computing devices (e.g., software) can cause one or more processors of the system to perform the steps of the embodiments described herein.

While the present disclosure describes electronic communications between the mobile unit and the exercise apparatuses by near field communication, electronic communication between the mobile unit and the exercise apparatuses may be facilitated by any other suitable wireless technology.

While the present disclosure describes a system used to monitor exercise equipment in a gymnasium or fitness center, a person of ordinary skill in the art would appreciate that the present disclosure may apply to managing various forms of equipment in various facilities, such as dormitories, libraries, and common areas. The system of the present disclosure may also be used to monitor the availability of study rooms or other common study areas in, for example, a library, dormitory, study hall, or other academic facilities.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry desired program code means in the form of computer-executable instructions or data structures and which can be accessed by a general-purpose or special-purpose computer. Combinations of the above should also be included within the scope of computer-readable media

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smartphones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, one or more versions of the present disclosure may be implemented as a method, apparatus, or article of manufacture using standard programming and/or engineering techniques to produce software, firmware, hardware, or any combination thereof to control a computer or mobile unit to implement the disclosed aspects. Non-transitory computer-readable media can include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), flash memory devices (e.g., card, stick), memory of a server hosting an application store that permits downloads of an application, and other mediums on which one or more applications may be stored. Of course, those skilled in the art will recognize many modifications may be made to this configuration without departing from the scope of the disclosed aspects.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

What is claimed is:

1. A system for managing the use of exercise equipment, the system comprising:
one or more exercise apparatuses, the one or more exercise apparatuses comprising a network;
a mobile unit for communicating with the one or more exercise apparatuses, the mobile unit having a user control interface and a processor for executing a mobile application that activates content displayed on the user control interface, the mobile unit communicating with an electronic circuit coupled to the one or more exercise apparatuses when the mobile unit is placed in proximity to the electronic circuit; and
a booking server in electronic communication with the mobile unit, the booking server being a computing device having a processor that stores a database of information concerning the status of the one or more exercise apparatuses.

2. The system of claim 1, wherein the mobile unit broadcasts a location identifier to the booking server, the location identifier being unique to the mobile device and represents location information of the mobile device relative to a certain object receiving the location identifier.

3. The system of claim 1, wherein the one or more exercise apparatuses may include selectorized strength equipment, free weight strength equipment, or plate-loaded strength machine.

4. The system of claim 1, wherein the user may use the system to manage the use of a fitness studio or recreation room.

5. The system of claim 1, wherein the mobile unit communicates with the electric circuit via near-field communication.

6. The system of claim 5, wherein the electric circuit is a near-field communication chip affixed to an exercise apparatus.

7. The system of claim 6, wherein the electric circuit is energized with the mobile unit is placed near the electric circuit, the electric circuit transmitting data to the mobile unit comprising an alphanumeric identifier.

8. The system of claim 7, wherein the mobile application is launched when the mobile unit is placed near the electric circuit and the content displayed on the user control interface is a check-in feature interface.

9. The system of claim 8, wherein when the mobile application is launched it generates a first status signal comprising the alphanumeric identifier, the first status signal being transmitted from the mobile unit to the booking server.

10. The system of claim 9, wherein upon receiving the first status signal, the booking server searches that database to match the alphanumeric identifier with information concerning an exercise apparatus associated with a serial number having the name alphanumeric characters, the computing device delineates the exercise apparatus associated with a serial number having the same alphanumeric characters as the alphanumeric identifier, and updates the status of the delineated exercise apparatus in the database from “available” to “in use.”

11. The system of claim 10, wherein the electric circuit is energized and the mobile application is launched when the mobile unit is placed near the electric circuit a second time, the electric circuit transmitting data to the mobile unit comprising an alphanumeric identifier.

12. The system of claim 11, wherein when the mobile application has launched the content displayed on the user control interface is a check-out feature interface and the mobile application generates a second status signal comprising the alphanumeric identifier.

13. The system of claim 12, wherein the second status signal is transmitted from the mobile unit to the booking server and, upon receiving the second status signal, the booking server searches that database to match the alphanumeric identifier with information concerning an exercise apparatus associated with a serial number having the name alphanumeric characters, the computing device delineates the exercise apparatus associated with a serial number having the name alphanumeric characters as the alphanumeric identifier, and updates the status of the delineated exercise apparatus in the database from “in use” to “available.”

14. The system of claim 1, further comprising an administrative panel for inputting information concerning the status of the one or more exercise apparatuses into the database, the administrative panel being a computing device.

15. The system of claim 1, where the booking server communicates with the mobile unit via a public network, including an Internet, cellular-based wireless, Wi-Fi, or cloud-based networking wireless connection.

16. A method of managing the use of an exercise activity, the method comprising:
populating a database stored on a computing device with information concerning one or more exercise activities, the information including a unique serial number assigned to each exercise activity;
launching a mobile application executed by a mobile unit, the mobile unit being in electronic communication with the database via a wireless connection for receiving and transmitting information about the status of the one or more exercise activities;
energizing an electric circuit coupled to one or more exercise activities by placing the mobile unit in close proximity to the electric circuit, the electric circuit transmitting data comprising an alphanumeric identifier to the mobile unit, the data being processed by the mobile application to generate a status signal comprising the alphanumeric identifier;
transmitting the status signal from the mobile unit to the computing device where the database is searched to match the alphanumeric identifier with information concerning an exercise activity associated with a serial number having the same alphanumeric characters; the computing device delineating the exercise activity associated with a serial number having the name alphanumeric characters as the alphanumeric identifier;
updating the status of the delineated exercise activity in the database from “available” to “in use.”

17. The method of claim 16, further comprising energizing the electric circuit a second time by placing the mobile unit in close proximity to the electric circuit, the electric circuit transmitting data comprising the alphanumeric identifier to the mobile unit, the data being processed by the mobile application to generate a second status signal comprising the alphanumeric identifier;

18. The method of claim 17, further comprising transmitting the status signal from the mobile unit to the computing device where the database is searched to match the alphanumeric identifier with information concerning an exercise activity associated with a serial number having the name alphanumeric characters; the computing device delineating the exercise activity associated with a serial number having the name alphanumeric characters as the alphanumeric identifier;

19. The method of claim 18, further comprising updating the status of the delineated exercise activity in the database from “in use” to “available.”
